(19) United States
(12) Patent Application Publication
(10) Pub. No.: US 2026/0046747 A1
(43) Pub. Date: Feb. 12, 2026

(54) CONTROL APPARATUS, COMMUNICATION APPARATUS, CONTROL METHOD, AND STORAGE MEDIUM

(71) Applicant: CANON KABUSHIKI KAISHA, Tokyo (JP)

(72) Inventor: MASAKAZU TSUCHIHASHI, Kanagawa (JP)

(21) Appl. No.: 19/364,995

(22) Filed: Oct. 21, 2025

Related U.S. Application Data
(63) Continuation of application No. PCT/JP2024/015512, filed on Apr. 19, 2024.

(30) Foreign Application Priority Data
May 9, 2023 (JP) 2023-077247

(51) Int. Cl. H04W 48/08; H04W 48/02; H04W 64/00; H04W 76/20; H04W 88/08

(52) U.S. Cl. CPC H04W 48/08; H04W 48/02; H04W 64/00; H04W 76/20; H04W 88/08

(57) ABSTRACT

There is disclosed a control apparatus including a transmission unit configured to transmit a request to a mobile Integrated Access and Backhaul (IAB) node currently set for an access restriction, the request requesting the mobile IAB node to release the access restriction. Desirably, the transmission unit transmits a request in a case where a predetermined condition is satisfied. It is also desirable that the control apparatus further includes a first reception unit configured to receive a notification including information indicating no connectable base stations from User Equipment (UE), and the predetermined condition is satisfied upon reception of the notification.

### CROSS-REFERENCE TO RELATED APPLICATIONS

This application is a Continuation of International Patent Application No. PCT/JP2024/015512, filed Apr. 19, 2024, which claims the benefit of Japanese Patent Application No. 2023-077247, filed May 9, 2023, both of which are hereby incorporated by reference herein in their entirety.

### BACKGROUND

### Field of the Technology

The present disclosure relates to a control apparatus, a communication apparatus, a control method, and a storage medium.

### Description of the Related Art

In 3rd Generation Partnership Project (3GPP®), Integrated Access and Backhaul (IAB) is being standardized as a communication technique for backhaul.

The IAB technique refers to a technique for simultaneously using millimeter-wave wireless communications (e.g., 28 GHz band) used for access communication between a base station and user equipment (UE), as backhaul communication (Japanese Unexamined Patent Application Publication No. 2019-534625).

In backhaul communication based on the IAB technique, a relay apparatus called an IAB node relays communication from an IAB donor equivalent to a conventional base station through millimeter-wave communication. Further, the IAB node forms communication links with a plurality of other IAB nodes to form a network tree starting from the IAB donor, enabling area expansion.

In the IAB technique, communication between the IAB donor and an IAB node and communication between IAB nodes are controlled via Backhaul Adaptation Protocol (BAP).

BAP is prescribed mainly as a protocol for routing data between a plurality of IAB nodes.

In conventional specification studies related to IAB in 3GPP®, specifications have been developed for stationary base stations (non-mobile IAB nodes) for up to Release-17.

In 3GPP®, specifications for implementing a Vehicle Mounted Relay (a use case for Release-18) and the use case are presently planned to be developed.

With a Vehicle Mounted Relay, functions equivalent to an IAB node are assumed to be mounted on moving bodies such as automobiles and electric railcars. A Vehicle Mounted Relay is also referred to as a mobile IAB or mobile IAB node because of the characteristics of a moving IAB node. To actually operate such a mobile IAB node, various requirements that cannot be satisfied only by conventionally discussed specifications on the assumption of stationary base stations are required.

Mobile IAB nodes are expected to have a role of flexibly adjusting a public network as temporary nodes for widening the coverage area of the public network and alleviating congestion of the public network.

Mobile IAB nodes perform an access restriction for limiting connection partners to pieces of UE of a part of related persons such as owners and families of automobiles, and are also expected to have a role of being used as a vehicle mounted broadband line for individuals.

A possible use case enables the mobile IAB node to switch between an operation mode for assigning the former role to a mobile IAB node and an operation mode for assigning the latter role. A specific example will be described. Assume an example case of a mobile IAB node operating under an access restriction, having a role of being used as a broadband line for individuals. When the access restriction on the mobile IAB nodes is temporarily released to allow the use as a public network, congestions of the public network can be assumed to be flexibly alleviated.

However, there has been devised no mechanism for implementing switching between access restriction states of a mobile IAB node in a form highly convenient for users or communication carriers.

### SUMMARY

The present disclosure has been embodied in view of at least one of the above-described problems. According to an aspect of the present disclosure, the present disclosure is directed to providing a switching mechanism with high convenience for users or communication carriers.

A control apparatus according to an aspect of the present disclosure has a transmission unit configured to transmit a request to a mobile Integrated Access and Backhaul (IAB) node currently set for an access restriction, the request requesting the mobile IAB node to release the access restriction.

Features of the present disclosure will become apparent from the following description of embodiments with reference to the attached drawings.

### BRIEF DESCRIPTION OF THE DRAWINGS

FIG. 1 is a block diagram illustrating hardware functions of an Integrated Access and Backhaul (IAB) donor and a mobile IAB node according to the present disclosure.

FIG. 2A is a block diagram illustrating software functions of the IAB donor according to the present disclosure.

FIG. 2B is a block diagram illustrating software functions of the mobile IAB node according to the present disclosure.

FIG. 3 illustrates a system configuration according to a first embodiment.

FIG. 4 is a sequence diagram according to the first embodiment.

FIG. 5 is a flowchart illustrating operations of User Equipment (UE) according to the first embodiment.

FIG. 6 is a flowchart illustrating operations of the IAB donor according to the first embodiment.

FIG. 7 is a flowchart illustrating operations of the mobile IAB node according to the present disclosure.

FIG. 8 illustrates a system configuration according to a second embodiment.

FIG. 9 is a sequence diagram according to the second embodiment.

FIG. 10 is a flowchart illustrating operations of an IAB donor according to the second embodiment.

FIG. 11 is a sequence diagram according to a third embodiment.

FIG. 12 illustrates a system configuration according to a fourth embodiment.

FIG. 13 is a sequence diagram according to the fourth embodiment.

FIG. 14 is a flowchart illustrating operations of UE according to the fourth embodiment.

FIG. 15 is a flowchart illustrating operations of an IAB donor according to the present embodiment.

FIG. 16 is a flowchart illustrating operations of a mobile IAB node according to the present embodiment.

### DESCRIPTION OF THE EMBODIMENTS

Embodiments of the present disclosure will be described below with reference to the accompanying drawings.

### First Embodiment

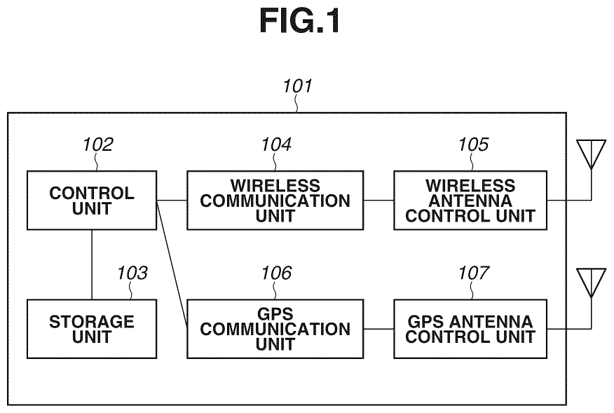

FIG. 1 is a block diagram illustrating hardware functions of an Integrated Access and Backhaul (IAB) donor according to a first embodiment. Although FIG. 1 is a block diagram illustrating hardware functions of the IAB donor, the hardware functions of the mobile IAB node may also be similar to those of the IAB donor. For example, the following descriptions will be made on the premise that the IAB donor and the mobile IAB node have similar hardware configurations.

A hardware function block 101 of the IAB donor and the mobile IAB node includes a control unit 102, a storage unit 103, a wireless communication unit 104, a wireless antenna control unit 105, a global positioning system (GPS) communication unit 106, and a GPS antenna control unit 107.

The control unit 102 controls the entire apparatus by executing a control program stored in the storage unit 103. The control unit 102 including, for example, at least one processor such as a central processing unit (CPU) and a micro processing unit (MPU) controls the entire communication apparatus by executing a control program loaded into a random access memory (RAM) serving as the storage unit 103. Each piece of processing of flowcharts (described below) executed by the control unit 102 can also be implemented by using hardware circuitry such as an application specific integrated circuit (ASIC) and a field programmable gate array (FPGA). The processing of flowcharts (described below) can also be implemented through the collaboration of hardware circuitry and the CPU or MPU.

The storage unit 103 stores the control program to be executed by the control unit 102, and other various information such as a cell identifier (ID) and information about connected pieces of UE. The storage unit 103 may include a main and an auxiliary storage unit. The main storage unit is, for example, a read only memory (ROM) or a RAM. The main storage unit may store or temporarily save programs including an operating system (OS) serving as basic software and application software to be executed by the control unit 102, and data. The auxiliary storage unit may include a hard disk drive (HDD) and a solid-state drive (SSD) for storing data related to application software and the like. For example, the control program stored in a nonvolatile storage area is loaded into the RAM and executed by the processor included in the control unit 102. Thus, the control unit 102 and the storage unit 103 may function as what is called a computer.

The wireless communication unit 104 performs cellular network communication such as Long-Term Evolution (LTE) and Fifth Generation (5G) New Radio (NR) conforming to the 3GPP® standard.

The wireless antenna control unit 105 controls the antenna used for wireless communication performed by the wireless communication unit 104.

The GPS communication unit 106 receives satellite signals from a Global Positioning System (GPS) satellite and acquires current position information including location information such as longitude and latitude information. The GPS communication unit 106 can have a function of measuring the current position based on the satellite signals.

The GPS antenna control unit 107 controls an antenna (not illustrated) used for communication executed by the GPS communication unit 106.

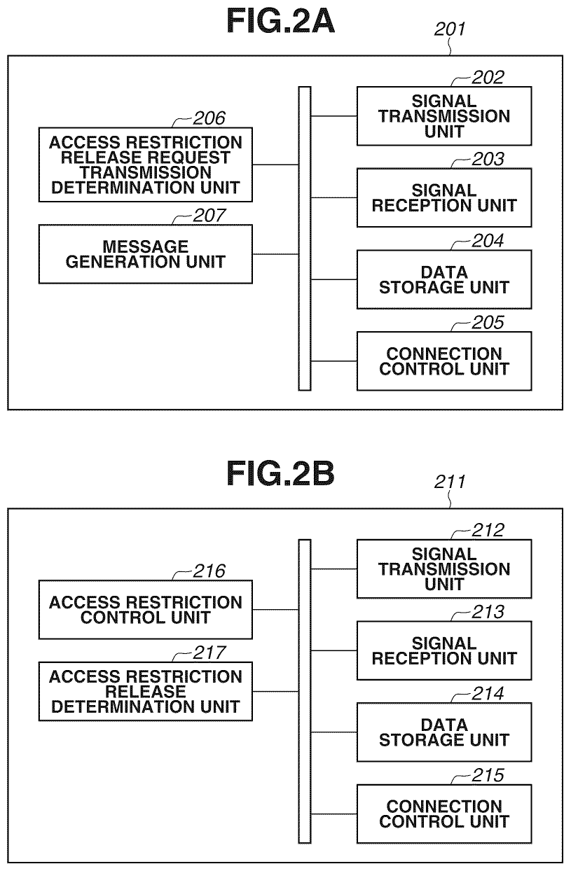

FIG. 2A is a block diagram illustrating software functions of an IAB donor according to the present embodiment.

A software function block 201 of the IAB donor is stored in the storage unit 103 and executed by the control unit 102.

The software function block 201 includes a signal transmission unit 202, a signal reception unit 203, a data storage unit 204, a connection control unit 205, an access restriction release request transmission determination unit 206, and a message generation unit 207.

The signal transmission unit 202 and the signal reception unit 203 control the wireless communication unit 104 via the control unit 102, and executes cellular network communication such as LTE and 5G conforming to the 3GPP® standard with UE and an external apparatus.

The data storage unit 204 controls and manages the storage unit 103 serving as an entity, and stores and holds software itself, cell information, and information about pieces of UE and mobile IAB nodes connected to the IAB donor and the like. The connection control unit 205 also controls the wireless antenna control unit 105 via the control unit 102 during wireless communication.

The access restriction release request transmission determination unit 206 determines whether to notify the mobile IAB nodes of an access restriction release request. According to the present embodiment, the access restriction release request transmission determination unit 206 determines to transmit a release request to the mobile IAB node upon reception of a notification “No connectable base stations” from the UE and/or upon request to transmit a release request from an external apparatus.

The access restriction release request transmission determination unit 206 can also add a state of the self-station (IAB donor) to determination criteria. For example, the access restriction release request transmission determination unit 206 determines not to transmit a release request to the mobile IAB node in a case where the number of pieces of UE connectable to the self-station has not reached the upper limit when a notification “No connectable base stations” is received from the UE. The access restriction release request transmission determination unit 206 can also detect that the number of connectable pieces of UE frequently reaches the upper limit and that the communication quality is low (the throughput between the self-station and the UE is degraded), and determine to transmit a release request to the mobile IAB node.

The message generation unit 207 generates an access restriction release request message to be notified to the mobile IAB node.

FIG. 2B is a block diagram illustrating software functions of a mobile IAB node according to the present embodiment.

A software function block 211 of the mobile IAB node includes a communication transmission unit 212, a communication reception unit 213, a data storage unit 214, a connection control unit 215, an access restriction control unit 216, and an access restriction release determination unit 217.

The configurations of the units 212 to 215 are similar to those of the units 202 to 205, respectively, described above with reference to FIG. 2A, and descriptions thereof will be omitted.

The access restriction control unit 216 controls the access restriction on the UE connected to the self-station. In a case where access restriction is enabled, the access restriction control unit 216 permits only access from a specific UE. In a case where access restriction is disabled, the access restriction control unit 216 permits access from all pieces of UE.

The access restriction release determination unit 217 determines whether to release the access restriction according to an access restriction release request from outside. Possible access restriction release conditions include a permission to release the access restriction by the owner of the mobile IAB node. A response to an access restriction release request can be set in advance, or a permission to release the access restriction can be checked via the UE or the like of the owner upon notification of the release request.

The access restriction release determination unit 217 can also determine to restart the access restriction. Conditions for restarting the access restriction include that a predetermined elapse of time period has been passed since the last reception of an access restriction release request and that an instruction or the like for restarting the access restriction has been issued from the owner.

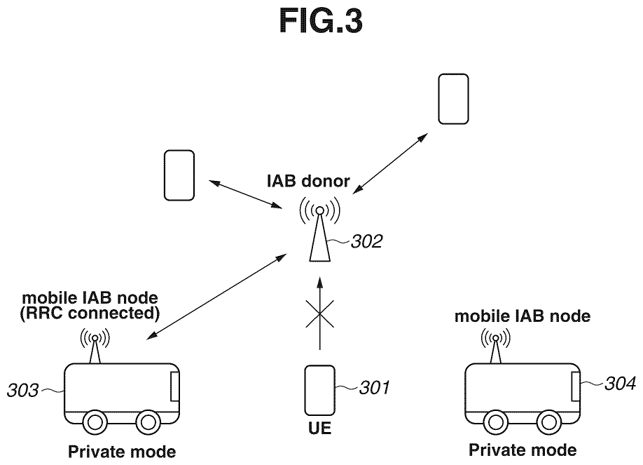

FIG. 3 illustrates an example of a system configuration according to the present embodiment.

A mobile communication system includes an IAB donor 302 to be connected to a core network (CN), and UE 301, a mobile IAB node 303, a mobile IAB node 304, and a plurality of other pieces of UE around the IAB donor 302.

The mobile IAB node 303 and the plurality of other pieces of UE connect to the IAB donor 302, and the number of apparatuses connected to the IAB donor 302 has reached the upper limit. The mobile IAB node 303 connects to the IAB donor 302, and the access restriction is enabled. The mobile IAB node 304 connects to a base station other than the IAB donor 302. Alternatively, the mobile IAB node 304 is currently operating in a Radio Resource Control (RRC) Idle state. More specifically, the mobile IAB node 304 may be in a state in which none of base stations are connected to the mobile IAB node 304 and the access restriction is enabled.

The UE 301 does not have an access right of the mobile IAB nodes 303 and 304. According to the present embodiment, the access restriction on the mobile IAB node uses the Closed Access Group (CAG) function. The CAG function is one of functions for non-public networks prescribed by 3GPP®. A non-public network is sometimes abbreviated to NPN. More specifically, the CAG function refers to a function of the base station configuring an NPN to control the access right of the UE 301. The base station transmits a CAG ID, which is an identifier (ID) of the NPN, to the UE 301. The UE 301 having received the CAG-ID collates the CAG ID with an accessible CAG list stored in the UE 301 itself to confirm the presence of the access right. In a case where the access right of the base station is absent, the base station is excluded from the connection processing target. In this situation, the UE 301 can detect only the IAB donor 302 as a base station, and cannot connect to the IAB donor 302 because the number of connected pieces of UE has reached the upper limit. Thus, the UE 301 is in a state “No connectable base stations”.

Processing for releasing the access restriction on the mobile IAB nodes 303 and 304 to connect the UE 301 to a cellular network in this situation will now be described.

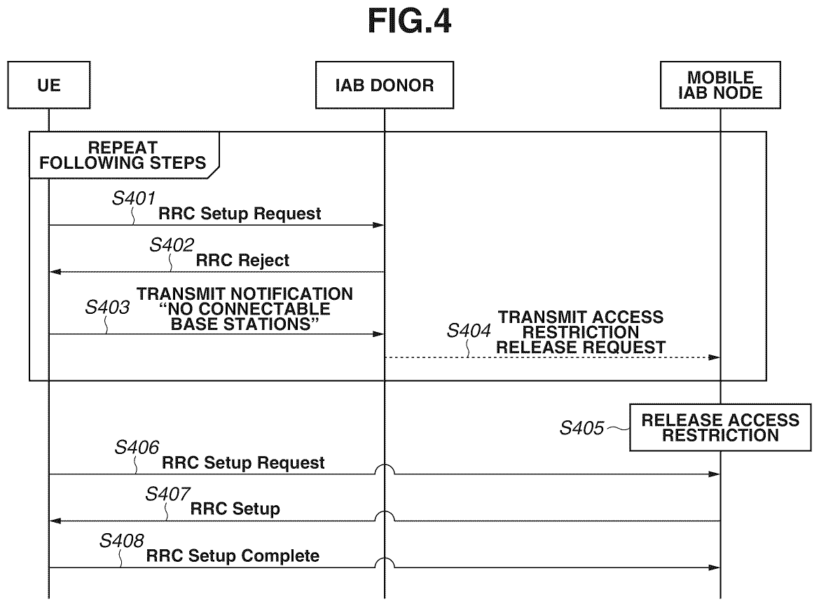

FIG. 4 is a sequence diagram according to the present embodiment.

In step S401, UE (hereinafter referred to as the UE 301) transmits a connection request (RRC Setup Request) to the IAB donor 302. Upon reception of the connection request, the IAB donor 302 determines not to allow the UE 301 to connect to the self-station since the number of pieces of UE connected to the self-station has reached an upper limit. In step S402, the IAB donor 302 transmits a connection rejection (RRC Reject) to the UE 301. Upon reception of the connection rejection, the UE 301 determines that the UE 301 is in a state “No connectable base stations” where the UE 301 can connect to none of detectable base stations.

In step S403, the UE 301 transmits a notification “No connectable base stations” to the IAB donor 302. In a case where a plurality of detectable base stations exists, the UE 301 transmits the relevant notification to the base station having highest field intensity. Although, in the present embodiment, the UE 301 transmits the relevant notification only to the IAB donor 302, the UE 301 can also transmit the relevant notification to a plurality of base stations. Like the case of the connection request, the UE 301 uses the RRC protocol as the notification method. The RRC protocol refers to a layer-3 protocol used in communication between UE and a base station in LTE and 5G systems. For 5G, the relevant protocol is prescribed in TS 38.331. The UE 301 transmits a notification “No connectable base stations” by using the message format of the connection request (RRC Setup Request). The RRC Setup Request includes an item named “Establishment Case” for entering a reason for connection. When the UE 301 adds a new definition of the notification “No connectable base stations” and enters the definition as this item, the UE 301 before connecting to the cellular network (RRC IDLE) can transmit a notification “No connectable base stations” to the base station. Although the present embodiment uses RRC Setup Request, a new message format can also be defined.

Upon reception of the notification “No connectable base stations” from the UE 301, the IAB donor 302 transmits, in step S404, an access restriction release request to the mobile IAB node.

Two different notification methods can be considered. More specifically, as a first method, there is a method of notifying the mobile IAB node connected to the self-station (IAB donor 302), such as the mobile IAB node 303. As a second method, there is a method of notifying the mobile IAB node not connected to the self-station, such as the mobile IAB node 304.

In the first method, since the notification has been made to the mobile IAB node connected to the self-station, the transmission destination is clear. For example, a BAP message can be used to notify the Backhaul Adaptation Protocol (BAP) address of the mobile IAB node. A BAP message refers to a layer-2 protocol used to route data for the IAB node in the 5G system prescribed by 3GPP®. BAP is prescribed by TS 38.340. The UE 301 can transmit the relevant request to the mobile IAB node by using F1 Application Protocol (F1AP) instead of the BAP message. F1AP is prescribed by TS 38.473. The following information items are included in the notification message:
Information item 1: Request content
Information item 2: Period
   The information item 1 includes pieces of time information such as “Start access restriction release”, “Stop access restriction release”, and the like in the request content thereof. Although not mentioned in the present embodiment, including “Start access restriction” and “Stop access restriction” also makes it possible to enable the access restriction on the mobile IAB node from outside. The information item 2 includes the effective period of a change request in the period thereof. This item is used to perform determination when the mobile IAB node that responds to the access restriction release request restarts the access restriction. In a case where the period is a short time, the mobile IAB node can restart the access restriction without waiting for the request “Stop access restriction release” after an effective period has elapsed. Upon reception of the request “Stop access restriction release” from the IAB donor 302 during the effective period, the mobile IAB node can restart the access restriction.

With the first method, the mobile IAB node as the notification destination can be a part or all of the mobile IAB nodes forming the IAB network. In the case of a part of the mobile IAB nodes, these mobile IAB nodes can include mobile IAB nodes existing in the vicinities of pieces of UE (pieces of UE that cannot connect to the base station).

In the second method, since the notification has been made to the mobile IAB node not connected to the self-station, the transmission destination is unknown. Thus, the IAB donor 302 notifies the mobile IAB nodes existing around the self-station of an access control request by issuing notification information to the periphery of the self-station. For the notification, for example, System Information Block (SIB) is used. Like the first method, the following information is also included in the notification information for the second method. The following information items are included in the notification information:
Information item 1: Request content
Information item 2: Period
   Steps S401 to S404 are periodically repeated while the UE 301 cannot connect to the base station.

Upon reception of the access restriction release request, the mobile IAB node determines whether to release the access restriction via a determination unit (described below). In a case where the mobile IAB determines to release the access restriction, then in step S405, the mobile IAB node releases the access restriction.

When the mobile IAB node releases the access restriction, the UE 301 is allowed to detect the mobile IAB node, and starts the connection processing on the detected mobile IAB node. Subsequently, the UE 301 performs processing for establishing a connection to the mobile IAB node according to the processing for establishing UE connection described in 3GPP® specifications TS 38.300.

In step S406, the UE 301 transmits a connection request (RRC Setup Request) to the mobile IAB node. In a case where the mobile IAB node is connectable, in step S407, the mobile IAB node transmits RRC Setup to the UE 301. This message includes cell configuration information and the like necessary for connection processing. In step S408, the UE 301 transmits connection completion (RRC Setup Complete) to the mobile IAB node, and the connection processing completes.

Next, processing in each apparatus in the above-described sequence will be described with reference to flowcharts.

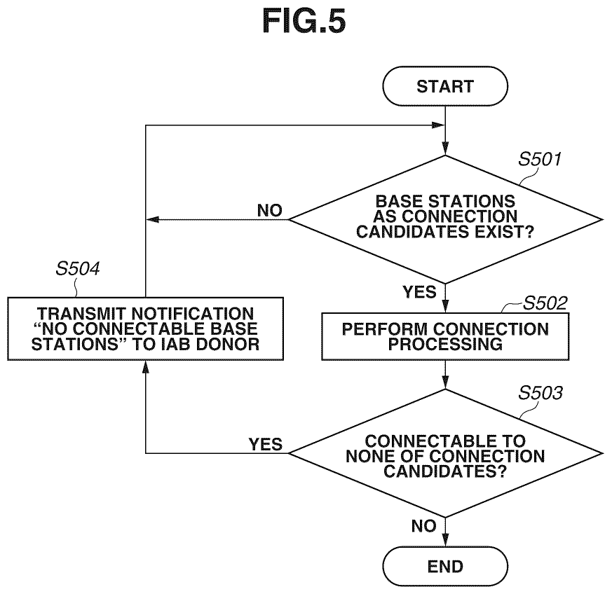

FIG. 5 is a flowchart illustrating operations of UE (UE 301) according to the first embodiment.

Steps S501 to S503 indicate UE connection processing described in 3GPP® specifications TS 38.300.

In step S501, the UE 301 determines whether base stations to be connection candidates exist around the UE 301 based on information transmitted from the base stations. In a case where base stations to be connection candidates exist (YES in step S501), the processing proceeds to step S502.

In step S502, the UE 301 sequentially subjects the base stations to be connection candidates to connection processing based on the priority.

In step S503, the UE 301 confirms the result of the connection processing. In a case where the UE 301 can establish a connection to none of the base stations to be connection candidates (YES in step S503), the processing proceeds to step S504. In a case where the UE 301 can establish a connection to any one of the base stations (NO in step S503), the processing ends.

In step S504, the UE 301 transmits a notification “No connectable base stations” to the base station as a connection candidate. The notification method is as described above with reference to step S403 in FIG. 4. When the transmission is completed, the processing returns to step S501 to repeat the above-described processing.

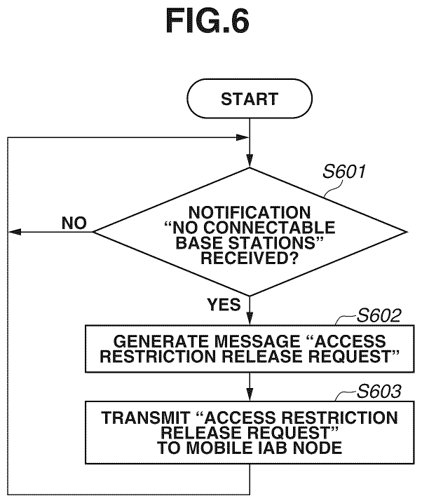

FIG. 6 is a flowchart illustrating operations of the IAB donor 302 according to the first embodiment.

In step S601, the access restriction release request transmission determination unit 206 of the IAB donor 302 determines whether to transmit “Access restriction release request”. According to the present embodiment, the IAB donor 302 performs the determination according to whether the notification “No connectable base stations” has been received from the UE 301. In a case where the notification has been received (YES in step S601), the processing proceeds to step S602.

In step S602, the IAB donor 302 generates a message “Access restriction release request” to be transmitted to a mobile IAB node. The message to be generated is as described above with reference to step S404 in FIG. 4. The IAB donor 302 generates a BAP message for the mobile IAB node to be connected to the self-station, and notification information for the mobile IAB nodes existing around the IAB donor 302. In a case where a plurality of mobile IAB nodes is connected to the self-station, a BAP message can be generated for a part or all of the mobile IAB nodes. Although, in the present embodiment, the IAB donor 302 generates both a BAP message and notification information, the IAB donor 302 can generate only either one. In a case where the UE 301 issues an access restriction release request to the mobile IAB node based on the notification “No connectable base stations”, “Start access restriction release” is included in “Information item 1: Request content”, and “Short time” is included in “Information item 2: Period”, as information included in the message. This is because the recovery of the UE 301 is merely a temporary measure. In addition, the mobile IAB node can be moved out of the cell range of the IAB donor 302 and hence is not necessarily able to receive an “Access restriction stop request” from the IAB donor 302. The mobile IAB node sets an effective period to restart the access restriction by the determination of the mobile IAB node without waiting for the “Access restriction stop request” from the IAB donor 302.

In step S603, the IAB donor 302 transmits the generated message “Access restriction release request” to the mobile IAB node. When the transmission is completed, the processing returns to step S601 to repeat the above-described processing.

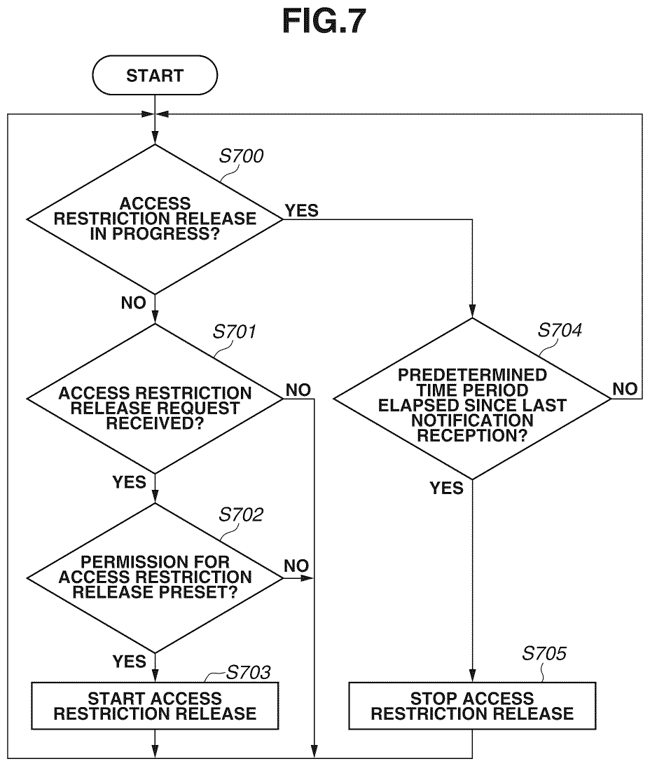

FIG. 7 is a flowchart illustrating operations of a mobile IAB node according to the present embodiment.

In step S700, the access restriction release determination unit 217 of the mobile IAB node determines whether the access restriction release processing is in progress. In a case where the access restriction release processing is in progress (YES in step S700), the processing proceeds to step S704. In a case where the access restriction release processing is not in progress (NO in step S700), the processing proceeds to step S701.

In step S701, the mobile IAB node confirms whether the “Access restriction release request” has been received from the IAB donor 302. In a case where the request has been received (YES in step S701), the processing proceeds to step S702. In a case where the relevant request has not been received (NO in step S701), the processing returns to step S700 for the next processing cycle.

In step S702, the access restriction release determination unit 217 of the mobile IAB node determines whether an access restriction release condition is satisfied. According to the present embodiment, the mobile IAB node performs determination according to whether the owner of the mobile IAB node has set the permission to release the access restriction in advance. The setting of the permission to release the access restriction is stored in the data storage unit 214. In a case where the condition is satisfied (YES in step S702), the processing proceeds to step S703. In a case where the relevant condition is not satisfied (NO in step S702), the processing returns to step S700 for the next processing cycle.

In step S703, the access restriction control unit 216 of the mobile IAB node starts, in a case where the access is restricted, the access restriction release. Then, the processing returns to step S700 for the next processing cycle.

In step S704, the access restriction release determination unit 217 of the mobile IAB node determines whether an access restriction restart condition is satisfied. According to the present embodiment, the access restriction release determination unit 217 performs the determination according to whether a predetermined time period has elapsed since the last reception of the “Access restriction release request”. For the predetermined time period, the value of “Period” included in the lastly received “Access restriction release request” is used. An upper limit of the predetermined time period may also be provided by the owner. In a case where either the value of “Period” in the release request or the upper limit preset by the owner has elapsed, the access restriction release determination unit 217 determines that the access restriction restart condition is satisfied. In this case (YES in step S704), the processing proceeds to step S705. In step S705, the mobile IAB node stops the access restriction release and restarts the access restriction. In a case where the mobile IAB node determines that the access restriction restart condition is not satisfied (NO in step S704), the processing returns to step S700 for the next processing cycle.

The present embodiment has been described above centering on processing in which, upon reception of the notification “No connectable base stations” from the UE 301, the IAB donor 302 transmits an access restriction release request to the surrounding mobile IAB nodes. This enables releasing the access restriction on the mobile IAB nodes from outside, making it possible to recover unconnectable pieces of UE.

### Second Embodiment

According to the first embodiment, the IAB donor 302 transmits an access restriction release request to the surrounding mobile IAB nodes based on the reception of the notification “No connectable base stations” from the UE 301. A second embodiment will be described below centering on processing for transmitting an access restriction release request to the surrounding mobile IAB nodes based on a notification of an external apparatus other than UE.

Examples of possible use cases according to the second embodiment include a resolution of a communication congestion at a communication carrier.

In a case where a communication congestion is expected because an event is held in a specific area, the communication carrier identifies base stations (IAB donors) installed in the area based on base station installation information managed by the communication carrier itself. The communication carrier instructs the identified base stations to transmit an access restriction release request to surrounding mobile IAB nodes. This enables temporarily increasing the number of base stations in a specific area to increase the number of connectable pieces of UE.

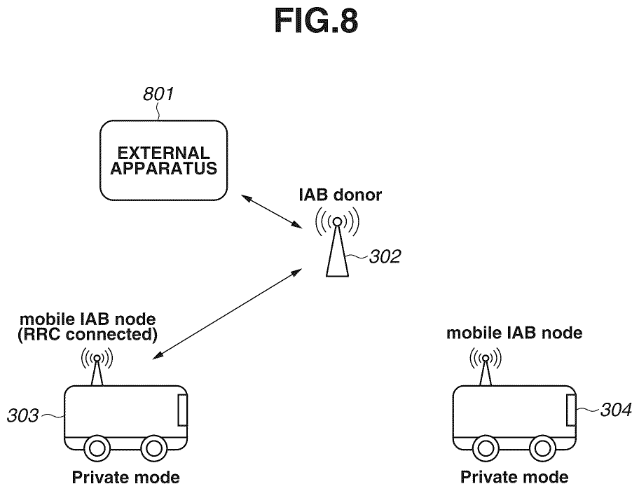

FIG. 8 illustrates an example of a system configuration according to the present embodiment.

The IAB donor 302 is installed in a specific area, and mobile IAB nodes 303 and 304 exist around the IAB donor 302. The mobile IAB nodes 303 and 304 are similar to those according to the first embodiment. An external apparatus 801 can communicate with the IAB donor 302 via a mobile communication system.

Processing for releasing the access restriction on the mobile IAB nodes 303 and 304 via the IAB donor 302 from the external apparatus 801 under such a situation will now be described.

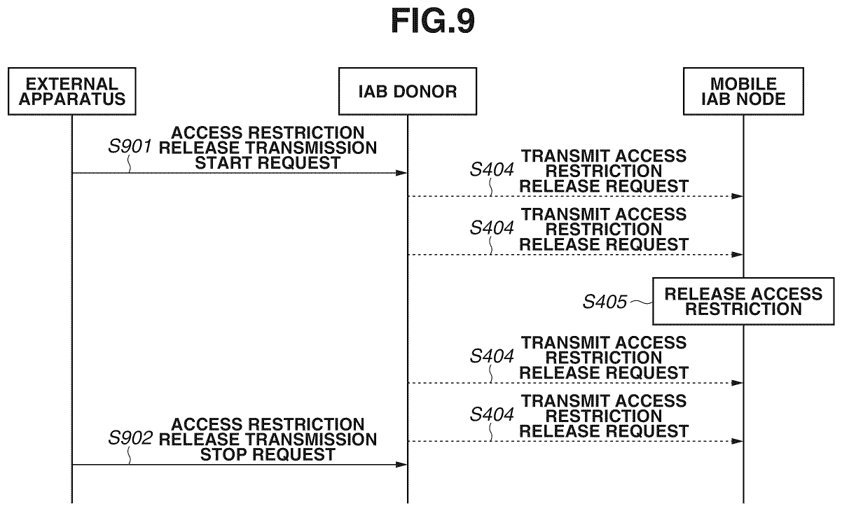

FIG. 9 is a sequence diagram according to the present embodiment.

In step S901, the external apparatus 801 transmits an access restriction release transmission start request to the IAB donor 302.

The access restriction release transmission start request is used to request the IAB donor 302 to start the transmission of requests to the mobile IAB node. More specifically, the access restriction release transmission start request is used to request the IAB donor 302 to start processing for transmitting “Access restriction release requests” to the mobile IAB node. In a case where the external apparatus 801 is a core network (5GC), the 5GC and the base station are connected with a Next Generation (NG) interface. Messages in the Application layer via the NG interface are prescribed by specifications TS 38.413. The access restriction release start request and an access restriction release stop request (described below) according to the present embodiment use messages newly defined in conformance with the specifications. The following information items are included in the same message:
Information item 1: Request content
Information item 2: Period
Information item 3: Content to be included in access restriction release request “Information item 1: Request content” includes “Start transmission”, “Stop transmission”, and the like. “Information item 2: Period” includes an effective period of a notification request. “Information item 3: Content to be included in access restriction release request” includes information about the content to be included in an access restriction release request message to be transmitted from the IAB donor 302 having received the access restriction release transmission start request to the surrounding mobile IAB nodes. According to the present embodiment, “Start transmission” is included in “Information item 1: Request content”, “Indefinite period” is included in “Information item 2: Period”, and “Request content (Start access restriction release) and “Period (short time)” are included in “Information item 3: Content to be included in access restriction release request”. According to the present embodiment, the external apparatus 801 and the IAB donor 302 are stationary apparatuses permanently capable of communicating with each other. Thus, to reduce the communication traffic between the external apparatus 801 and the IAB donor 302, “Indefinite period” is included in “Information item 2: Period” so that an access restriction release transmission start request needs to be transmitted only once. The IAB donor 302 having received the access restriction release transmission start request transmits an access restriction release request to the surrounding mobile IAB nodes. The transmission unit and content are similar to those according to the first embodiment, and descriptions thereof will be omitted. The mobile IAB node having received the access restriction release request also releases the access restriction like the first embodiment, and descriptions thereof will be omitted. The IAB donor 302 maintains periodical transmission of the access restriction release request. Upon reception of an access restriction release transmission stop request from the external apparatus 801 in step S902, the IAB donor 302 stops the transmission of the access restriction release request. For the access restriction release transmission request from the external apparatus 801, “Stop transmission” is included in “Information item 1: Request content”, and “Indefinite period” is included in “Information item 2: Period”.

Referring to FIG. 9, the IAB donor 302 transmits an access restriction release request to the surrounding mobile IAB nodes. In this case, the access restriction release request may be broadcasted not to a specific mobile IAB node but to the surrounding mobile IAB nodes. In the example illustrated in FIG. 9, even after one mobile IAB node releases the access restriction, the IAB donor 302 periodically transmits an access restriction release request before step S902. The mobile IAB nodes existing around the IAB donor 302 may change during the period from step S901 to step S902. For example, one mobile IAB node existing around the IAB donor 302 at a certain timing may not exist around the IAB donor 302 at a certain subsequent timing. From this point, in the processing illustrated in FIG. 9, the IAB donor 302 periodically transmits an access restriction release request. Thus, this processing is desirable under a situation in which mobile IAB nodes existing around the IAB donor 302 can dynamically change. More specifically, even under such a situation, the processing illustrated in FIG. 9 enables the IAB donor 302 to transmit an access restriction release request to one or more mobile IAB nodes around the IAB donor 302 with high reliability.

Processing of each apparatus in the above-described sequence will now be described.

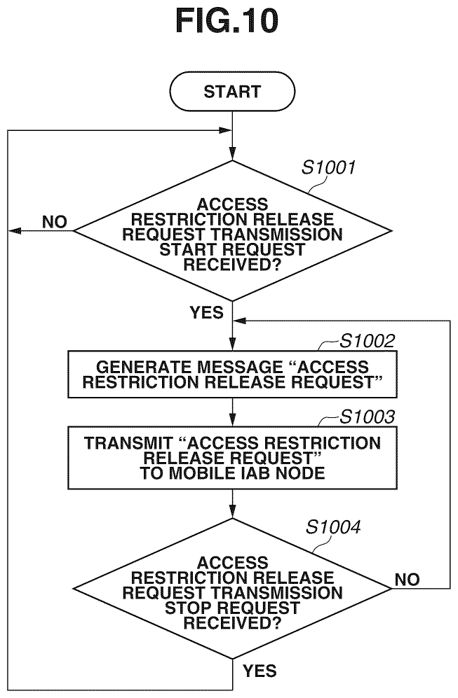

FIG. 10 is a flowchart illustrating operations of the IAB donor 302 according to the present embodiment.

In step S1001, the access restriction release request transmission determination unit 206 of the IAB donor 302 determines whether to transmit an “Access restriction release request”. According to the present embodiment, the IAB donor 302 performs the determination according to whether the “Access restriction release transmission start request” is received from the external apparatus 801. In a case where the request is received (YES in step S1001), the processing proceeds to step S1002. In a case where the request is not received (NO in step S1001), the IAB donor 302 enters a reception wait state.

In step S1002, the message generation unit 207 of the IAB donor 302 generates a message “Access restriction release request” to be transmitted to a mobile IAB node. The message to be generated is similar to that in step S602. The content to be included in the message is determined based on “Information item 3: Content to be included in access restriction release request” included in the access restriction release transmission start request received from the external apparatus 801 in step S1001. When the message is generated, the processing proceeds to step S1003.

In step S1003, the IAB donor 302 transmits an “Access restriction release request” to the mobile IAB node. The processing content is similar to that of step S603. When the transmission is completed, the processing proceeds to step S1004.

In step S1004, the access restriction release request transmission determination unit 206 determines whether to stop the transmission of the “Access restriction release request”. According to the present embodiment, the access restriction release request transmission determination unit 206 performs the determination according to whether the “Access restriction release transmission stop request” has been received from the external apparatus 801. In a case where the request has been received (YES in step S1004), the processing returns to step S1001 to repeat the above-described processing. In a case where the request has not been received (NO in step S1004), the processing returns to step S1002 again. Then, the IAB donor 302 performs processing for transmitting an access restriction release request.

Operations of the mobile IAB node are similar to the above-described operations in FIG. 7 according to the first embodiment, and descriptions thereof will be omitted.

The second embodiment has been described above centering on processing in which, upon reception of the “access restriction release transmission start request” from the external apparatus 801, the IAB donor 302 transmits an access restriction release request to the surrounding mobile IAB nodes. This can enable releasing the access restriction on the unspecified number of mobile IAB nodes existing in a specific area from outside.

### Third Embodiment

In the above-described embodiments, the IAB donor 302 transmits an access restriction release to the unspecified number of mobile IAB nodes existing around the IAB donor 302. However, there may be a use case where only a specific mobile IAB node wants to change the access restriction, such as a case where the owner of the mobile IAB node changes the access restriction of the mobile IAB node by remote control from the UE 301 or the server owned by the owner of the mobile IAB node.

A third embodiment will now be described centering on a method for directly transmitting an access restriction release request from an external apparatus to a mobile IAB node.

An example of a system configuration according to the present embodiment is similar to that in FIG. 8, however, the external apparatus 801 is replaced with an external apparatus 802. In a use case according to the third embodiment, the external apparatus 802 refers to a server apparatus or the like that receives an instruction of the owner of the mobile IAB node and transmits an access restriction release request to the mobile IAB node. For example, instructions of the owner of the mobile IAB node are obtained, for example, by disclosing an application programming interface (API) of an access restriction release request to an application function (AF). The external apparatus 802 and the IAB donor 302 are connected with each other via the NG interface like the external apparatus 801 and the IAB donor 302 according to the second embodiment. A notification from the external apparatus 802 to the mobile IAB node is transmitted to the mobile IAB node via the IAB donor 302 based on a routing protocol such as a BAP message.

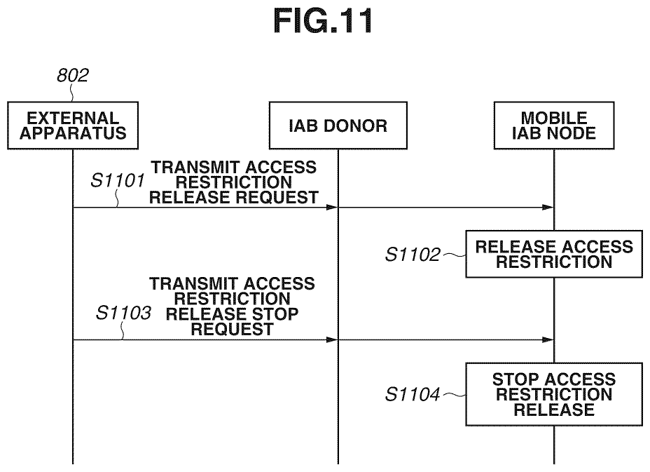

FIG. 11 is a sequence diagram according to the present embodiment.

In step S1101, the external apparatus 802 transmits an access restriction release request to a mobile IAB node. The content of the access restriction release request is similar to that of the messages transmitted from the IAB donor 302 to the mobile IAB node according to the first and the second embodiments. However, the access restriction release request can be transmitted to a specific mobile IAB node by unicast.

In this case, “Start access restriction release” is included in “Information item 1: Request content”, and “Indefinite period” is included in “Information item 2: Period”. This allows settings to be continued until the owner issues a request “Stop access restriction release”. Upon reception of the access restriction release request, the mobile IAB node releases the access restriction in step S1102.

In step S1103, the external apparatus 802 transmits an access restriction release stop request to the mobile IAB node. The message is similar to that in step S1101. For the message, “Stop access restriction release” is included in “Information item 1: Request content”, and “Indefinite period” is included in “Information item 2: Period”. Upon reception of the access restriction release stop request, the mobile IAB node stops the access restriction release in step S1104.

The flowchart illustrating operations of a mobile IAB node according to the present embodiment is similar to that in FIG. 7 according to the first embodiment, and descriptions thereof will be omitted.

The third embodiment has been described above centering on processing in which the external apparatus 802 transmits an “Access restriction release request” to a specific mobile IAB node. This enables releasing the access restriction on a specific mobile IAB node from outside.

### Fourth Embodiment

According to the first and the second embodiments, an access restriction release request is transmitted to all of the unspecified number of mobile IAB nodes existing in the cell of the IAB donor 302. However, in a case where the area subjected to the access restriction release is limited (e.g., a case where the area is comparatively small), an access restriction release request will be transmitted to the larger number of mobile IAB nodes than necessary. A fourth embodiment will be described centering on a method for limiting the area subjected to the access restriction release. As an example of area limitation, a method for issuing an access restriction release request to the area surrounding UE having no connectable base stations according to the first embodiment.

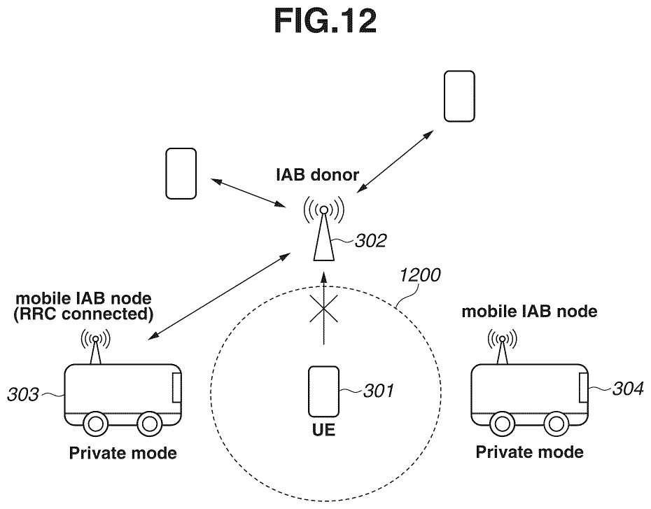

FIG. 12 illustrates an example of a system configuration according to the present embodiment.

Referring to the example illustrated in FIG. 12, an access restriction release request area 1200 is added to the system configuration according to the first embodiment illustrated in FIG. 3. The access restriction release request area 1200 is an area set to surround the UE 301 having no connectable base stations. Releasing the access restriction only on the mobile IAB nodes existing near this area enables limiting the area subjected to the access restriction release. Information about this area is generated by the IAB donor 302. Based on UE's position information transmitted by pieces of UE, the IAB donor 302 sets a range that includes all of the pieces of UE having no connectable base stations, and transmits generated range information to the mobile IAB nodes 303 and 304. Upon reception of the range information, each mobile IAB node compares its position with the range information to determine whether to release the access restriction. The area subjected to the access restriction release can be limited in this way.

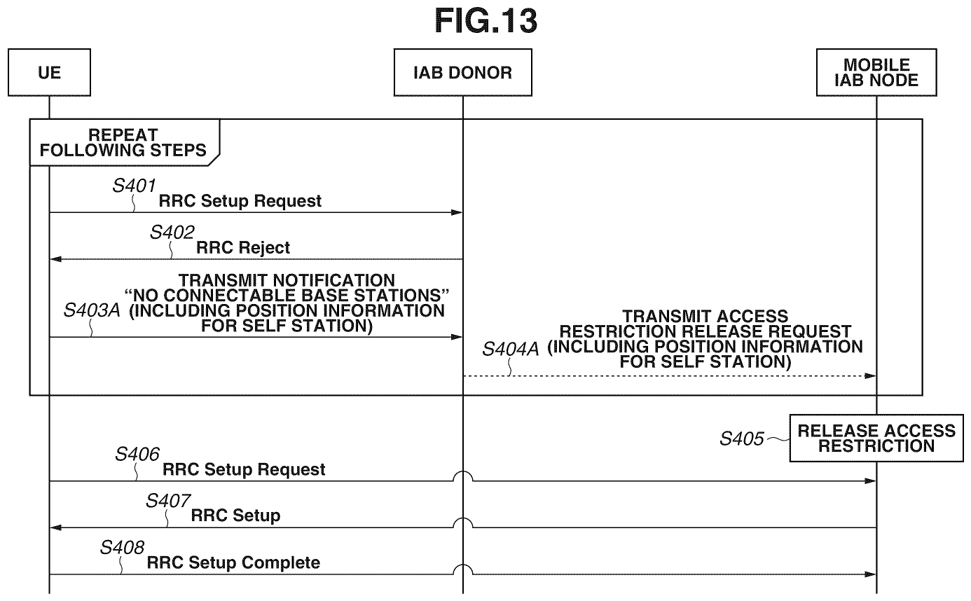

A sequence according to the present embodiment will now be described with reference to FIG. 13.

FIG. 13 is a sequence diagram according to the present embodiment.

Steps S401 and S402 are similar to those in FIG. 4 according to the first embodiment, and descriptions will be omitted.

In step S403A, the UE 301 transmits a notification “No connectable base stations” to the IAB donor 302. In this case, the UE 301 includes its position information in the message. Unlike the first embodiment, the transmission method does not use the format of RRC Setup Request. In this case, a new message format is used in which the current UE's position information is added to RRC Setup Request. The present embodiment will be described centering on the content in which the IAB donor 302 identifies the position of the UE 301 based on the message transmitted from the UE 301. However, the IAB donor 302 can identify the position of the UE 301 based on information such as the radio wave intensity and the like of the UE 301, without including the position information in the notification.

Upon reception of the notification from the UE 301, the IAB donor 302 sets a range such that all of the pieces of UE 301 having no connectable base stations are included based on the position information for the pieces of UE 301. In a case where the IAB donor 302 receives the notification again from the same UE 301, the IAB donor 302 updates the position information for the UE 301 and sets the range information.

In step S404A, the IAB donor 302 transmits an access restriction release request to the mobile IAB node. The set range information is included in this request. The transmission method is similar to that according to the first embodiment.

The mobile IAB node having received the access restriction release request determines whether to release the access restriction. In a case where the mobile IAB node determines to release the access restriction, the processing proceeds to step S405 in which the mobile IAB node releases the access restriction. The mobile IAB node determines whether to release the access restriction based on the received range information as well as on the presence of the owner's permission according to the first embodiment. For example, in a case where the position of the self-station is included in the area of the range information, the mobile IAB node determines to release the access restriction. The mobile IAB node can perform the determination at a timing of reception of the access restriction release request. Alternatively, the mobile IAB node can temporarily store the received range information and determine again at a timing when the mobile IAB node moves to the area included in the range information. The mobile IAB node can include its radio wave performance, moving speed, staying time for an assumed range, and other information in a determination condition.

When the mobile IAB node releases the access restriction, the UE 301 becomes able to detect the mobile IAB node and starts the connection processing like the first embodiment. Steps S406 to S408 are similar to those in FIG. 4 according to the first embodiment, and descriptions thereof will be omitted.

Operations of each apparatus will be described below. Operations are basically similar to those according to the first embodiment.

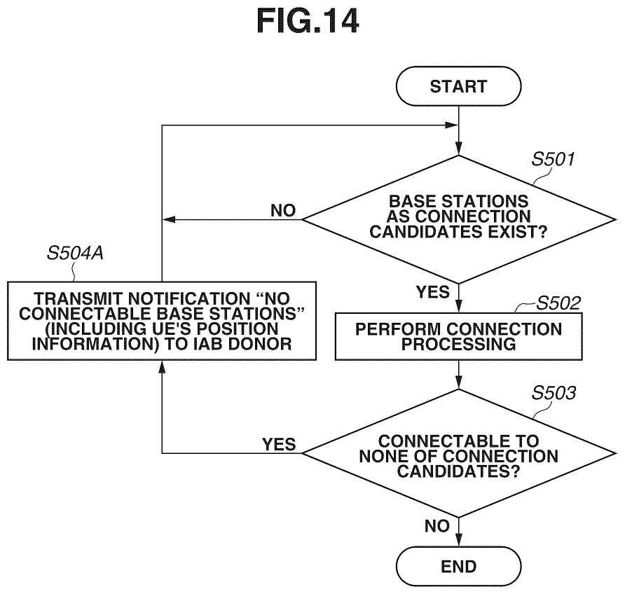

FIG. 14 is a flowchart illustrating operations of the UE 301 according to the present embodiment. Steps S501 to S503 are similar to those in FIG. 5 according to the first embodiment, and descriptions thereof will be omitted.

In step S504A, the UE 301 transmits a notification “No connectable base stations” to the IAB donor 302. At this time, the UE 301 includes the UE's position information in the message.

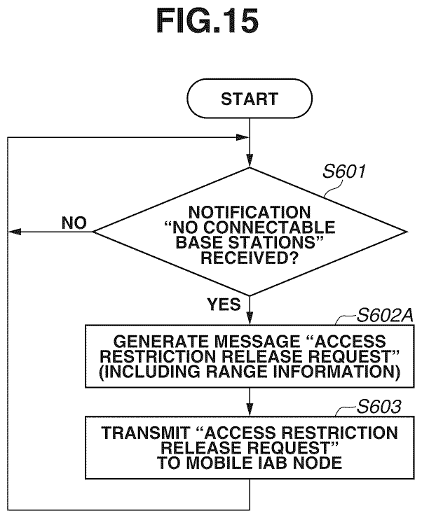

FIG. 15 is a flowchart illustrating operations of the IAB donor 302 according to the present embodiment.

Step S601 is similar to that in FIG. 6 according to the first embodiment, and descriptions thereof will be omitted.

In step S602A, the IAB donor 302 generates a message “Access restriction release request” to be transmitted to a mobile IAB node. At this time, the IAB donor 302 includes the range information set based in the UE's position information in the message. Step S603 is similar to that in FIG. 6 according to the first embodiment, and descriptions thereof will be omitted.

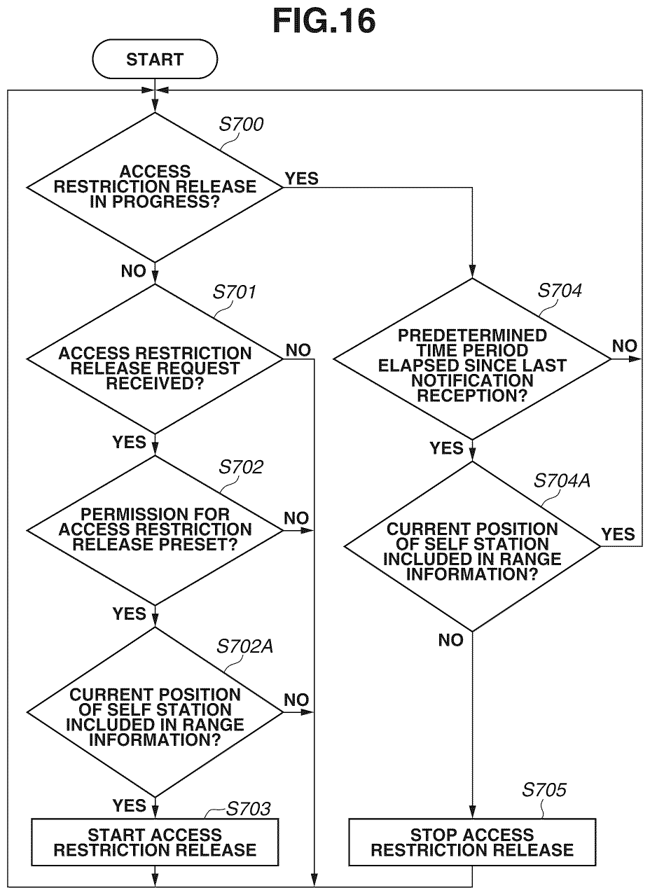

FIG. 16 is a flowchart illustrating operations of a mobile IAB node according to the present embodiment.

Steps S700 and S701 are similar to those in FIG. 7 according to the first embodiment, and descriptions thereof will be omitted.

In steps S702 and S702A, the access restriction release determination unit 217 determines whether the access restriction release condition is satisfied. According to the present embodiment, the access restriction release determination unit 217 performs the determination according to whether the permission to release the access restriction is set by the owner of the mobile IAB node (step S702) in advance, and according to whether the current position of the self-station is included in the received range information (step S702A). In a case where the current position of the self-station is included in the range information (YES in step S702A), the processing proceeds to step S703. In step S703, the mobile IAB node starts the access restriction release. In a case where the current position of the self-station is not included in the range information (NO in step S702A), the processing returns to step S700 for the next processing cycle.

Step S703 is similar to that in FIG. 7 according to the first embodiment, and descriptions thereof will be omitted.

In steps S704 and S704A, the access restriction release determination unit 217 of the mobile IAB node determines whether the access restriction restart condition is satisfied. According to the present embodiment, the access restriction release determination unit 217 performs the determination according to whether a predetermined time period has elapsed since the last reception of the “Access restriction release request” (step S704) and according to whether the current position of the self-station is included in the last received range information (step S704A). In a case where the current position of the self-station is not included in the range information (NO in step S704A), the processing proceeds to step S705. In a case where the current position of the self-station is included in the range information (YES in step S704A), the processing returns to step S700 for the next processing cycle.

Step S705 is similar to that in FIG. 7 according to the first embodiment, and descriptions thereof will be omitted.

The fourth embodiment has been described above centering on processing for limiting the range of the mobile IAB nodes subjected to the access restriction release by including the range information in the access restriction release request. This enables releasing the access restriction on the mobile IAB nodes existing in a specific area from outside. According to the present embodiment, the IAB donor 302 sets the range information based on UE's position information. However, the range information can be directly specified (set) from outside by including the range information in an access restriction release request transmission request from the external apparatus 802 according to the second embodiment, and an access restriction release request message from the external apparatus 802 according to the third embodiment.

According to the present embodiment, the size of the area indicated by the range information can be constant or variable. For example, the area indicated by the range information can be dynamically changed to cover a region in which pieces of UE exist with a comparatively high density. The area indicated by the range information can also be changed according to the presence of an event, time zone, season, and the like.

While the present disclosure has specifically been described in detail based on different embodiments, the present disclosure is not limited to the specific embodiments but can be modified and changed in various ways within the scope of the appended claims. All or a plurality of components of the above-described embodiments can also be combined.

For example, according to the above-described embodiments, a mobile IAB node has two different access restriction states: a state where the access restriction is set and a state where the access restriction is (completely) released. However, the present embodiment is not limited thereto. For example, a mobile IAB node can have three different access restriction states: a state where the access restriction is set, a state in which the access restriction is partially released, and a state where the access restriction is completely released. In this case, according to the first embodiment (as well as other embodiments), the IAB donor 302 can transmit a request for requesting to partially release the access restriction to the target mobile IAB node. Alternatively, the mobile IAB node may form a state in which the access restriction is partially released in response to a request from the IAB donor 302.

According to the above-described embodiments, a mechanism for giving an incentive that receives an access restriction release request, to the mobile IAB node. For example, according to the number of receptions of the access restriction release request or the time zone when the request is received, the owner of the mobile IAB node can be given an incentive (points and the like). In this case, the increase in the number of mobile IAB nodes for receiving the access restriction release request can be expected, making it possible to improve the communication efficiency.

The third embodiment has been described above centering on an example case where the access restriction on a mobile IAB node is changed from an external apparatus by remote control via the IAB donor 302. In addition, the owner of the mobile IAB node can be configured to issue an instruction for changing the access restriction state from its own UE through direct wireless communication with the mobile IAB node. In this case, the mobile IAB node and the UE are connected by a wireless communication method such as Bluetooth® and the IEEE802.11 standard series. The UE wirelessly connected to the mobile IAB node by a wireless communication method such as Bluetooth® and the IEEE802.11 standard series receives an operation for changing the access restriction state via a setting screen (not illustrated). Upon detection of the reception of the change operation, the UE transmits an instruction for changing the access restriction state to the mobile IAB node. Upon reception of the change instruction, the mobile IAB node changes the access restriction state in collaboration with other IAB nodes, the IAB donor and the like.

The present disclosure is not limited to the above-described embodiments but can be modified and changed in various ways without departing from the spirit and scope of the present disclosure. Therefore, the following claims are appended to disclose the scope of the present disclosure.

An aspect of the present disclosure makes it possible to provide a mechanism for implementing switching between access restriction states of a mobile IAB node in a form highly convenient for users and communication carriers.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A control apparatus comprising:
a transmission unit configured to transmit a request to a mobile Integrated Access and Backhaul (IAB) node set for an access restriction, the request requesting the mobile IAB node to release the access restriction.

2. The control apparatus according to claim 1, wherein the transmission unit transmits the request in a case where a predetermined condition is satisfied.

3. The control apparatus according to claim 2, further comprising a first reception unit configured to receive a notification indicating no connectable base stations from a user equipment (UE), wherein the predetermined condition is satisfied in a case where the notification is received.

4. The control apparatus according to claim 3, wherein the first reception unit receives the notification from a radio resource control (RRC) message.

5. The control apparatus according to claim 3,
wherein the notification includes the UE's position information, and
wherein the transmission unit generates range information regarding a position range subjected to a release of the access restriction based on the position information, and includes the range information in the request.

6. The control apparatus according to claim 2, further comprising a second reception unit configured to receive a predetermined instruction from an external apparatus, wherein the predetermined condition is satisfied in a case where the predetermined instruction is received.

7. The control apparatus according to claim 6, wherein the predetermined instruction is generated in a case where an administrator or owner of the mobile IAB node permits to release the access restriction.

8. The control apparatus according to claim 2, wherein the predetermined condition is satisfied in a case where a state of an IAB donor of an IAB network related to the mobile IAB node is in a predetermined state.

9. The control apparatus according to claim 1, wherein the request includes at least one of pieces of information about a timing to start a release of the access restriction, information about a timing to end the release of the access restriction during execution, and range information regarding a position range subjected to the release of the access restriction.

10. The control apparatus according to claim 1, wherein the transmission unit transmits the request by using a Backhaul Adaptation Protocol (BAP), a System Information Block (SIB), or an F1 Application Protocol (F1AP).

11. The control apparatus according to claim 1, wherein the transmission unit repeatedly transmits the request to at least one unspecified mobile IAB node existing nearby.

12. The control apparatus according to claim 1, wherein the control apparatus functions as an IAB donor of an IAB network related to the mobile IAB node.

13. The control apparatus according to claim 1,
wherein the control apparatus is a control apparatus existing outside the IAB network related to the mobile IAB node, and
wherein the transmission unit of the control apparatus transmits the request via an IAB donor of the IAB network.

14. A communication apparatus comprising a notification unit configured to transmit a notification indicating no connectable base stations to at least one base station.

15. A communication apparatus comprising:
a processing unit configured to switch an access restriction state between a first state in which an access restriction is set and a second state in which the access restriction is not set or a degree of the access restriction is lower than a degree for the first state; and
an access control unit configured not to receive a connection request from a restriction target UE in the first state, and to receive a connection request from the restriction target UE in the second state,
wherein, in a case where a first request for requesting to release the access restriction in the first state is received, the processing unit performs switching from the first state to the second state.

16. The communication apparatus according to claim 15, wherein, in a case where the first request is received, the processing unit determines whether a switching condition from the first state to the second state is successful or failed.

17. The communication apparatus according to claim 15, wherein, in a case where a second request for requesting to stop the release of the access restriction in the second state is received, the processing unit performs switching from the second state to the first state.

18. The communication apparatus according to claim 15, further comprising a determination unit configured to determine whether the first request includes range information regarding a position range subject to a release of the access restriction, and whether a self-station exists within the position range,
wherein, upon reception of the first request, the processing unit performs switching from the first state to the second state in a case where the self-station exists within the position range based on a determination result of the determination unit.

19. A control method for controlling communication, the control method comprising:
transmitting a request to a mobile IAB node currently set for an access restriction, the request requesting the mobile IAB node to release the access restriction.

20. A storage medium storing a program for causing a computer to execute a method comprising:
transmitting a request to a mobile IAB node currently set for an access restriction, the request requesting the mobile IAB node to release the access restriction.

21. A control method for controlling communication, the method comprising:
switching an access restriction state between a first state in which an access restriction is set and a second state in which the access restriction is not set or a degree of the access restriction is lower than a degree for the first state; and
not receiving a connection request from a restriction target UE in the first state, and receiving a connection request from the restriction target UE in the second state,
wherein, in the switching, switching from the first state to the second state is performed in a case where a first request for requesting to release the access restriction in the first state is received.

22. A non-transitory storage medium storing a program for causing a computer to execute a method comprising:
switching an access restriction state between a first state where an access restriction is set and a second state where an access restriction is not set or a degree of the access restriction is lower than that in the first state; and
not receiving a connection request from a restriction target UE in the first state, and receiving a connection request from the restriction target UE in the second state,
wherein, in the switching, switching from the first state to the second state is performed in a case where a first request for requesting to release the access restriction in the first state is received.
